(19) United States
(12) Patent Application Publication
(10) Pub. No.: US 2026/0216807 A1
(43) Pub. Date: Jul. 30, 2026

(54) SOLDERING METHOD

(71) Applicant: Infineon Technologies AG, Neubiberg (DE)

(72) Inventors: Maximilian SIMMANN, Sinzing (DE); Alexander HEINRICH, Bad Abbach (DE)

(73) Assignee: Infineon Technologies AG, Neubiberg (DE)

(21) Appl. No.: 19/454,655

(22) Filed: Jan. 21, 2026

(30) Foreign Application Priority Data
Jan. 27, 2025 (DE) 10 2025 102 704.8

(51) Int. Cl. B23K 1/20; B23K 35/36

(52) U.S. Cl. CPC B23K 1/203; B23K 35/3612

(57) ABSTRACT

A soldering method is provided. The soldering method includes arranging a solder preform between a first metal surface and a second metal surface, arranging a reducing component between the first metal surface and the solder preform and between the second metal surface and the solder preform, and heating the solder preform to its melting temperature, which is higher than a boiling point of the reducing component, wherein the reducing component consists of: a reducing agent, or consists of: a reducing agent and a solvent, wherein the reducing agent consists of at least one of the following: a glycerol or its derivatives, a polyhydric alcohol (HOCH2(CHOH)nCH2OH with n=1 to 100), a polyethylene glycol (H—(O—CH2-CH2)n-OH (with n=1 to 1000), and a glycol (aliphatic diol), and wherein the solvent consists of at least one of the following: water, a glycol, an ether, glycolether, ethanol, propanol, and hexanol.

### CROSS-REFERENCE TO RELATED APPLICATION

This Utility patent application claims priority to German Patent Application No. 10 2025 102 704.8 filed Jan. 27, 2025, which is incorporated herein by reference.

### TECHNICAL FIELD

Various embodiments relate generally to a soldering method.

### BACKGROUND

Per- and polyfluoroalkyl substances (PFAs) are currently used in the art as tacking agents in soldering processes.

However, PFAs are highly toxic and detrimental for human health (bioaccumulation, cancer risk) and the environment.

Thus, a substitute for PFAs that is a non-toxic and environmentally friendly tacking agent is urgently required.

But an identification of a substitute is not straigthforward, due to special physicochemical properties of the PFA substance class. More specifically, PFAs provide a high boiling point, low surface tension, low viscosity, no residues after evaporation, a high vapor pressure, a low chemical reactivity, and they may be flame retardant.

### SUMMARY

A soldering method includes arranging a solder preform between a first metal surface and a second metal surface, arranging a reducing component between the first metal surface and the solder preform and between the second metal surface and the solder preform, and heating the solder preform to its melting temperature, which is higher than a boiling point of the reducing component, wherein the reducing component consists of: a reducing agent, or consists of: a reducing agent and a solvent, wherein the reducing agent consists of at least one of the following: a glycerol or its derivatives, a polyhydric alcohol (HOCH₂ (CHOH)ₙCH₂OH with n=1 to 100), a polyethylene glycol (H—(O—CH₂—CH₂)ₙ—OH (with n=1 to 1000), and a glycol (aliphatic diol), and wherein the solvent consists of at least one of the following: water, a glycol, an ether, glycolether, ethanol, propanol, and hexanol.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 illustrates, as a sequence of schematic drawings, a soldering method in accordance with various embodiments;

FIG. 2 graphically illustrates measured wetting properties of various reducing components, including reducing components for use in a soldering method in accordance with various embodiments;

FIGS. 3 and 4 each show solder distributions of various embodiments having been formed by a soldering method in accordance with various embodiments;

FIG. 5 shows a temperature profile of a soldering method in accordance with various embodiments;

FIG. 6 graphically illustrates a solder area coverage for different solder profiles of the soldering method in accordance with various embodiments;

FIG. 7A shows calculated vapor pressure curves of reducing components and solvents used in a soldering method in according with various embodiments, and of a reference material;

FIG. 7B shows results of a thermogravimetric analysis (TGA) of various reducing components used in a soldering method in according with various embodiments; and

FIG. 8 shows a flow diagram of a soldering method in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

A tacking agent is commonly used to attach a first connection partner to a second connection partner prior to soldering. During soldering, the tacking agent needs to evaporate essentially completely, in order to enable a void free soldering process.

Currently, a PFA substance with the brand name FC43 is used to achieve this, but will most likely be banned by ECHA, due to their global warming potential and toxicity for human health.

In various embodiments, a substitute is provided for currently used PFA substances, namely for FC43, and for formic acid, which is used as the reducing agent.

The substitute combines, in various embodiments, the tacking agent functionality (which may keep the components to be soldered in place before and during the soldering process) and the reducing agent functionality (which may activate a (metal) surface to be joined by the soldering, usually by reducing a metal oxide layer that has formed on the metal surface), and may therefore be referred to as a reducing tacking agent (RTA).

A PFA-free value chain, business continuity, and compliance with REACHS/ROHS regulations may thereby be provided. At the same time, lower process costs may be made possible, while providing an environmentally friendly and sustainable solution. Since liquids with reducing functionality typically also provide at least some level of tacking functionality, whereas only a subset of all liquids may act as a reducing agent, the reducing capability may be emphasized by referring to the substitute reducing tacking agent as a “reducing component”, and both terms may be used as synonyms herein in context with embodiments, unless it is explicitly stated or clear from the context that something else is intended.

The reducing component may in various embodiments be provided as a dispensable liquid (with comparatively high viscosity), or as a sprayable/jettable liquid (with comparatively low viscosity).

In various embodiments, glycerol may be used as the reducing tacking agent. Pure glycerol is not jettable/sprayable with usual equipment, at least at room temperature. For such applications, a viscosity adjustment may be applied to the reducing tacking agent, for example using a chemical viscosity adjustment, e.g. by adding a solvent, for example water or an ether, for example diethyleneglycolmonoethylether (DEGMEE), and/or for example using a physical viscosity adjustment, for example by increasing a temperature of the reducing tacking agent an/or of the spraying/jetting device, in particular around a valve or a nozzle from which the reducing tacking agend is sprayed/jettet, for example by increasing the temperature above room temperature (for pure glycerol, a temperature of about 85° C. may be suitable for decreasing the viscosity to around or below about 60 mPa*s) until a desired viscosity level (e.g., below 85 mPa*s, e.g., below about 60 mPa*s) is achieved.

In various embodiments, a first component (e.g., glycerol) with non-optimal physicochemical behavior (for example regarding viscosity, surface tension, boiling point, and/or vapor pressure) may be mixed with a second component (i.e. diethyleneglycolmonoethylether) to adjust the physicochemical behavior to enable jetting using productive equipment and to ensure an optimal evaporation during soldering.

In various embodiments, a combination is provided of a highly viscous polyhydric alcohol (e.g. glycerol) or glycol ethers (e.g. polyethylene glycol), which generate a reducing agent during heating, with a low-viscous mono- or polyhydric alcohol or glycol ether as a second component (acting as a solvent), which adjusts viscosity, surface tension, boiling point and/or vapor pressure to enable jetting using current equipment and to optimize evaporation of the tacking agent. As an example, glycerol works as a reducing agent, and the second component adjusts the physicochemical properties.

The above described reducing components/reducint tacking agents (combinations, mixtures, or essentially pure substances) may be used in a soldering method, for example a soldering method that makes use of a solder preform. The solder preform may be arranged between a first metal surface and a second metal surface, and the reducing component/reducing tacking agent may be arranged between the solder preform and each of the first metal surface and the second metal surface, respectively.

In various embodiments, a soldering method is provided. The soldering method includes arranging a solder preform between a first metal surface and a second metal surface, arranging a reducing component between the first metal surface and the solder preform and between the second metal surface and the solder preform, and heating the solder preform to its melting temperature, which is higher than a boiling point of the reducing component, wherein the reducing component consists of: a reducing agent, or consists of: a reducing agent and a solvent, wherein the reducing agent consists of at least one of the following: a glycerol or its derivatives, a polyhydric alcohol (HOCH₂ (CHOH)ₙCH₂OH with n=1 to 100), a polyethylene glycol (H—(O—CH₂—CH₂)ₙ—OH (with n=1 to 1000), and a glycol (aliphatic diol), and wherein the solvent consists of at least one of the following: water, a glycol, an ether, glycolether, ethanol, propanol, and hexanol.

Pure glycerol and glycerol derivatives, such as PEG-200 and PEG-300, were found to act as reducing agents in Vacuo/N₂-atmosphere on metal surfaces like Cu leadframes and direct copper bonds (DCBs). Therefore, other reducing agents (like oxalic acid, other acids (e.g., a formic acid atmosphere), resins, . . . ) are obsolete, and glycerol may be used as a main compound for activation during the preform soldering process.

Pure glycerol may mixed with a suitable solvent to adjust the physicochemical properties (viscosity, surface tension, vapor pressure, boiling point). Currently, the best results have been found for the solvent diethylenglycolmonoethylether (=DEGMEE) due to its optimal boiling point and low surface tension. Therefore, as an aspect of various embodiments, glycerol may be mixed with a solvent with low surface tension, high vapor pressure and a boiling point in a range from about 80° C. to about 250° C.

Various solvents may be used. See the table below for potential mixtures and their preferred ratio. Other solvents having the following combination of properties may also be feasible: low surface tension, low viscosity, high vapor pressure, high boiling point, wherein the specified usable solvents may be considered as references for the relative terms “high” and “low”. Also, PEG-200 and PEG-300 were identified as reducing agents and may be used as a substitute for glycerol.

| Reducing | | Optimal |
|---|---|---|
| agent | Solvent | Ratio [wt %] |
| glycerol | diethylene glycol monoethylether | 40:60 |
| glycerol | isopropanol | ~50:50 |
| glycerol | proplyene glycol methylether | ~50:50 |
| glycerol | α-/β-propylene glycol | ~30:70 |
| glycerol | triethylene glycol | ~30:70 |
| glycerol | H₂O | 70:30 |
| glycerol | ethylene glycol | ~30:70 |
| glycerol | diethylene glycol | ~30:70 |
| glycerol | diethylene glycol monomethylether | ~40:60 |

A boiling point of the reducing component may be selected or adjusted to be in a range from 80° C. to 290° C., for example between 120° C. and 180° C., and a melting point of the reducing component may be selected or adjusted to be below 20° C., e.g., below about 15° C.

At room temperature, a surface tension of the reducing component may be selected or adjusted to be in a range from 1×10⁻³ N/m to 80×10⁻³ N/m, for example between 1×10⁻³ N/m and 50×10⁻³ N/m.

At room temperature, a vapor pressure of the reducing component may be selected or adjusted to be in a range from 0.1 Pa to 2000 Pa, for example between 10 Pa and 1000 Pa.

A solvent may have a boiling point between about 80° C. and about 250° C.

A surface tension of the solvent may be below 50 dyne/cm.

A viscosity may be below 65 mPa*s.

A vapor pressure may be medium to high, above about 10 Pa.

Furthermore, the solvent may be non-hazardous.

For example DEGMEE may have a boiling point of about 200° C. and a surface tension of about 30 dyne/cm.

An advantage of a solvent with high vapor pressure and low surface tension is the optimized evaporation behavior during the soldering process, leading to faster and more complete evaporation as well as better spreading and continuous evaporation underneath the preform and underneath the chip. In contrast to this, mixtures with high surface tension and low vapor pressure tend to have immediate evaporation due to build-up of pressure underneath the preform and/or the chip, respectively, leading either to blow-off of the chip during soldering or large voids in the preform after soldering.

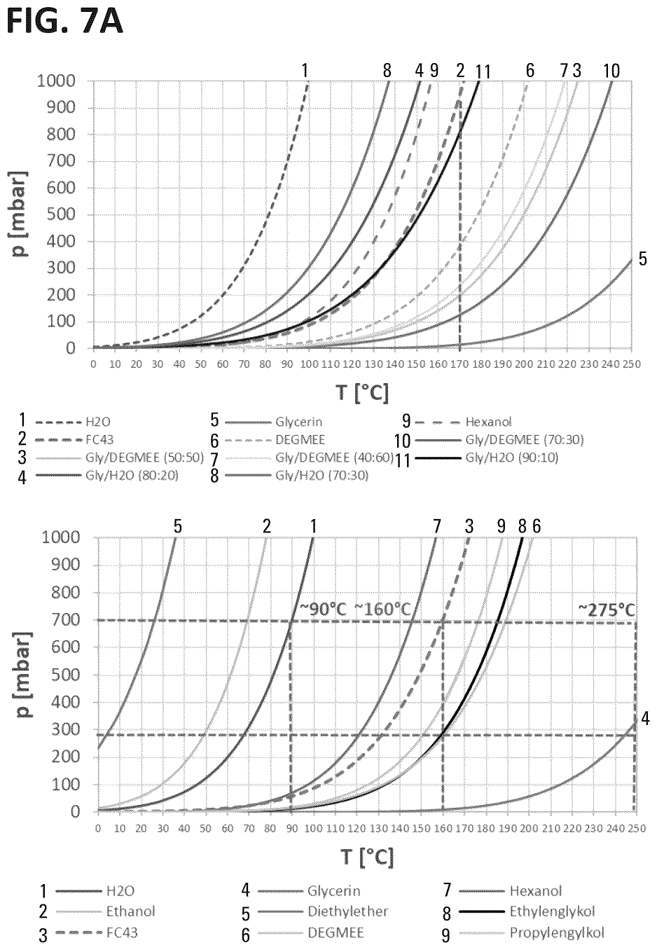

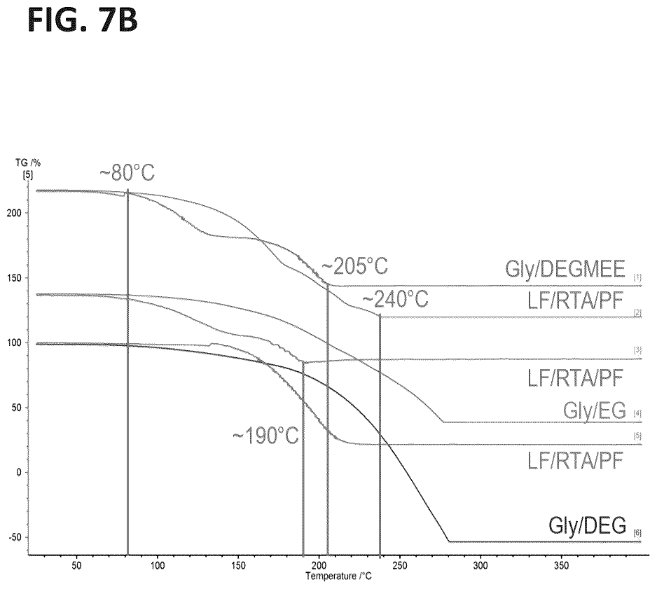

FIG. 7A shows, in two graphs, calculated vapor pressure over temperature curves of reducing components and solvents used in a soldering method in accordance with various embodiments, and of the reference material FC43, and FIG. 7B shows results of a thermogravimetric analysis (TGA) of various exemplary reducing components used in a soldering method in according with various embodiments. The calculation and analysis results may be taken into account for determining a temperature profile of a soldering method in accordance with various embodiments, for example for determining a temperature range in which a plateau or a slow ramp may be established for allowing the reducing component to evaporate (the dark grey area lasting for about four minutes, starting about eight minutes after the start of the soldering), and before the melting temperature of the solder, e.g., the solder preform, is reached (approximately starting around 17 minutes after start), and/or for selecting a solder material having a melting temperature above a temperature at which the reducing component is completely evaporated (in FIG. 7B, the temperature of complete evaporation is indicated as the temperature above which a respective TG %-value remains constant). The measurements shown in FIG. 7B indicate that it may be relevant to take the presence of the leadframe (LF) and the solder preform (PF) into account, since evaporation temperatures may differ for the reducing component by itself as opposed to the reducing component sandwiched between the leadframe and the solder preform (there are two graphs per reducing component, one with LF/PF and one without; each pair originates at the same TG value at approximately room temperature; the graphs are shifted along the y-axis for clarity.

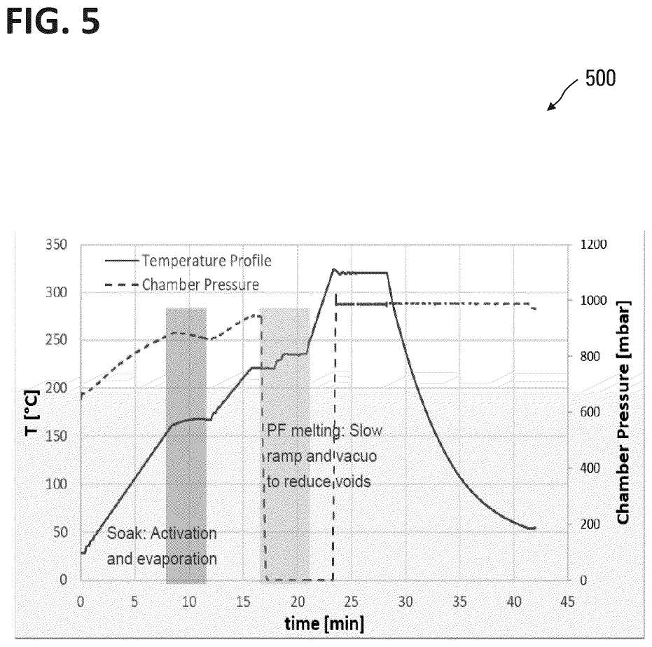

FIG. 5 shows an exemplary temperature profile (temperature over time) of a soldering method in accordance with various embodiments, which also specifies the corresponding chamber pressure.

Some features of solder profile include the following:

A slow ramp at 700 mbar to 160° C. to avoid fast evaporation of the reducing component and chip blow-off, a hold at 160° C. for activation of the leadframe and the solder preform and an evaporation of the reducing component; a ramp to 220° C. and a hold to further evaporate the reducing component; an evacution (“vacuo”) starting from 220° C. and a very slow ramp at the solder preform melting phase for reducing voids. After the solder preform melting, a ramp to 320° C. to form intermetallic phases.

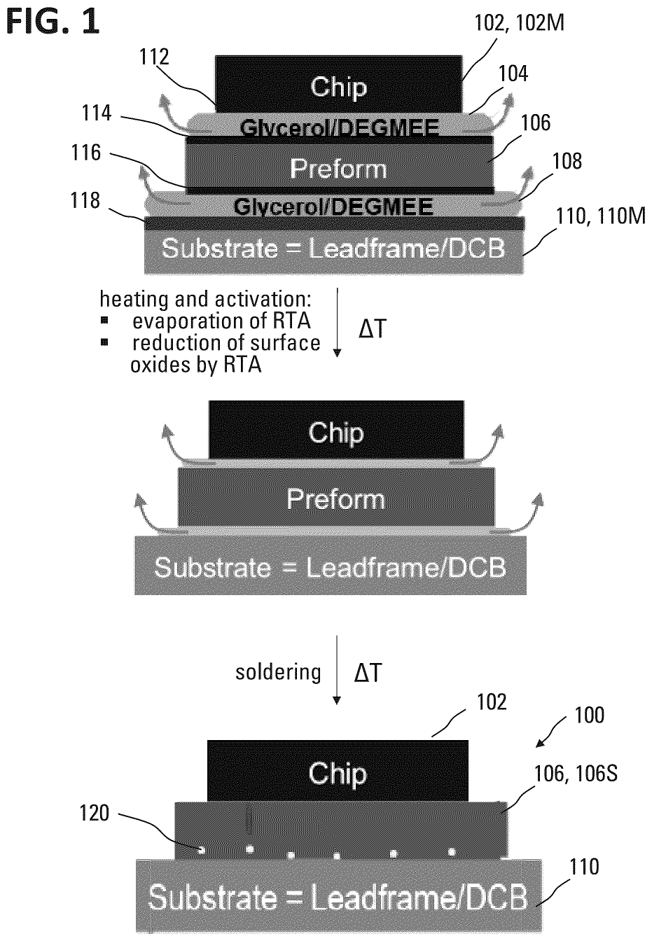

FIG. 1 illustrates, as a sequence of schematic drawings, a soldering method in accordance with various embodiments.

The soldering method includes arranging a solder preform 106 between a first metal surface 110M and a second metal surface 102M.

The first metal surface 110M may for example be or include at least a portion of a main surface of a substrate 110, for example of an essentially full metal substrate 110 like a leadframe, a clip, or the like, or of a substrate 110 that includes insulating material, like for example a printed circuit board, a ceramic substrate with a metal surface 110M, e.g., a direct copper bonded substrate (DCB), an insulated metal substrate, or the like. The metal of the first metal surface 110M may for example include or consist of: Ag, Au, Cu, Ni, NiP, Pd, Al/Ti/NiV/Ag, Al/Ti/NiV/Au, Ti/NiV/Ag, Ti/NiV/Au, and NiSi/Ti/NiV/Ag, alloys thereof, and/or various other metals.

The second metal surface 102M may for example be or include at least a portion of a main surface of a semiconductor chip 102, e.g., a chip pad, of any other semiconductor component, of an electrical or electronic component, or for example of a connection structure like a clip. The metal of the second metal surface 102M may for example include or consist of: Ag, Au, Cu, Ni, NiP, Pd, Al/Ti/NiV/Ag, Al/Ti/NiV/Au, Ti/NiV/Ag, Ti/NiV/Au, and NiSi/Ti/NiV/Ag, alloys thereof, and/or various other metals.

The metals of the first metal surface 110M and of the second metal surface 102M may be the same or may be different.

The solder preform 106 may include or consist of a solder material that is configured as an essentially solid preform, e.g., a block, a tablet, or a sheet, for example with a thickness in a range from 7 μm to 200 μm, that may be arranged as an entity. In other words, the solder preform 106 does not need to be dispensed, squeegeed, or the like. The solder preform 106 may include or consist of a solder material that is configured to form, after melting, an intermetallic compound as part of the solder connection established by the soldering method. After solidifying, the solder material 106 may additionally be referred to by the reference sign 106S. The solder material 106 may for example include a combination of low-melting metal solder particles that include or consist of at least one metal selected from the group consisting of Bi, Sn, Ga, Ge, Zn, and In and high-melting metal solder particles that include or consist of at least one metal selected from the group consisting of Ni, Cu, Ag, Au, Pt, and Pd, or any other solder material 106 that suitable for the soldering method, for example a solder material including any of the following materials: Sn, SnAg, SnAgCu, e.g. SAC305, SnCu, and SnSb, e.g. SnSb₂, SnSb₅, or SnSb₁₀, for example a solder preform material as known in the art.

The first metal surface 110M may have an oxide layer 118, the second metal surface 102M may have an oxide layer 112, and optionally also both main surfaces of the solder preform 106, may be have respective oxide layers 114, 116, for example formed as a native oxide that may form if a metal surface is exposed to an oxygen-containing atmosphere.

In order to enable or improve the soldering, the oxide layers 112, 114, 116, and 118 may need to be removed, for example by a reduction process. The removal of the oxide layer(s) is also referred to as “activation” of the respective metal surface.

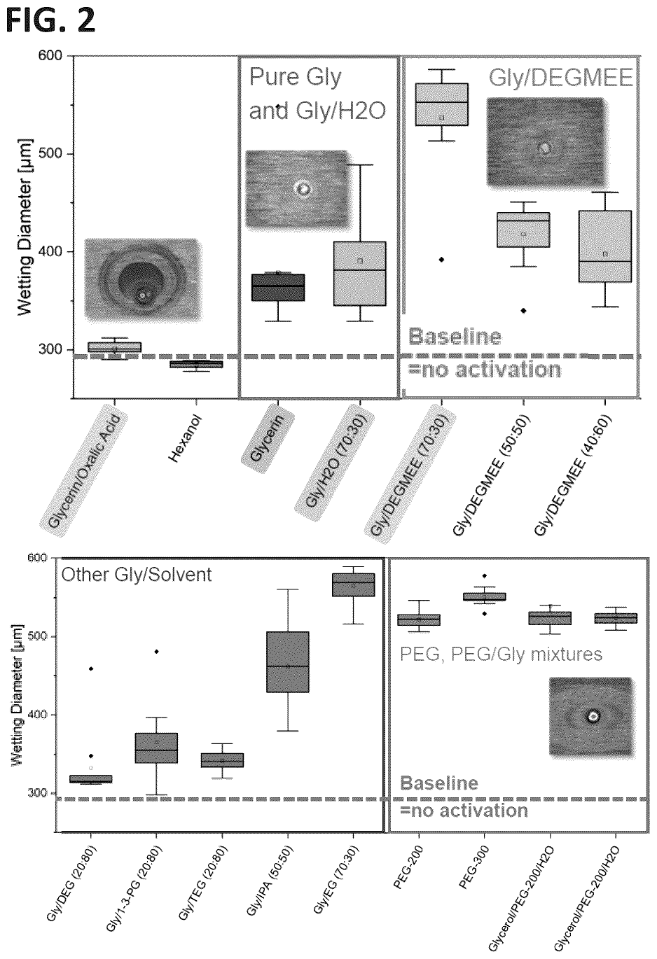

FIG. 2 graphically illustrates measured wetting properties of various reducing components 108, including reducing components 108 for use in a soldering method in accordance with various embodiments. The wetting properties, specifically, a wetting diameter measured in a solder ball test, may be indicative for presence or absence of an acitvation of the metal surface. Below a baseline of about 290 μm for the wetting diameter, the surface may have not been activated. For example, pure hexanol or a mixture of glycerin and oxalic acid may be unable to activate the surface, whereas the following liquids have been tested to show sufficient activation capabilities and may therefore be considered as the reducting component 108: pure glycerol, a mixture of glycerol with water (70:30), a mixture of glycerol with DEGMEE (70:30; 50:50; 40:60), a mixture of glycerol and diethylene glycol (20:80), a mixture of glycerol with 1-3-propolene glycol (20:80), a mixture of glycerol with triethylene glycol (20:80), a mixture of glycerol with IPA (50:50), a mixture of glycerol with ethylene glycol (70:30), pure PEG-200, pure PEG-300, and mixtures of glycerol with PEG-200 and water (50:20:30 wt % on the left and 40:30:30 wt % on the right).

To allow for the activation, the method may further include arranging a reducing component 108 between the first metal surface 110M and the solder preform 106 and between the second metal surface 102M and the solder preform 106.

Depending on a viscosity of the reducing component 108, which may generally be in a range from about 1 mPa*s to about 1000 mPa*s, the reducing component 108 may in various embodiments be arranged by jetting (from below) onto respective bottom surfaces, for example onto a bottom of the solder preform 106 and onto the second metal surface 102M facing downward, each just before placing the solder preform 106 and the second metal surface 102M (e.g., the chip 102), respectively.

In various embodiments, the reducing component 108 may be arranged on top surfaces during a subsequent stacking, for example be arranged (e.g., sprayed or jetted) onto the (upward facing) first metal surface 110M, be covered by the solder preform 106, then the reducing component 108 may be arranged (e.g., sprayed or jetted) onto the solder preform 106. Subsequently, the second metal surface 102M may be arranged on the reducing component 108 to sandwich the reducing component 108 between the solder preform 106 and the second metal layer 102M. Such a process may for example be used in a case where the reducing component 108 has a viscosity that is suitable for spraying or jetting, for example a viscosity lower than about 85 mPa*s, e.g., lower than about 60 mPa*s.

In a case of (e.g., substantially) higher viscosity, e.g., a viscosity between about 800 mPa*s and 1000 mPa*s, it may be possible to arrange (e.g., squeegee, print, dispense), e.g., before the stacking, the reducing component 108 on any one or both of the surfaces that sandwich the reducing component therebetween, e.g., on the first metal surface 110M and/or on a first (e.g., bottom) surface of the solder preform 106, and on the second metal surface 102M and/or on a second (e.g., top) surface of the solder preform 106. In particular, the reducing component 108 may optionally be arranged only on both (top and bottom) surfaces of the solder preform 106, or only on the first metal surface 110M and on the second metal surface 102M.

The method may further include heating (optionally, under a nitrogen atmosphere or in a vacuum) the solder preform 106 to its melting temperature, which is higher than a boiling point of the reducing component 108, wherein the reducing component 108 consists of: a reducing agent, or consists of: a reducing agent and a solvent, wherein the reducing agent consists of at least one of the following: a glycerol or its derivatives, a polyhydric alcohol (HOCH₂ (CHOH)ₙCH₂OH with n=1 to 100), a polyethylene glycol (H—(O—CH₂—CH₂)ₙ—OH (with n=1 to 1000), and a glycol (aliphatic diol), and wherein the solvent consists of at least one of the following: water, a glycol, an ether, glycolether, ethanol, propanol, and hexanol.

Some reducing components 108 that may be suitable for executing the soldering method of various embodiments are indicated above, below, and in the figures. Properties of some exemplary embodiments are specified in the following:

The reducing agent may account for 10 wt % to 100 wt % of the reducing composition 108.

The reducing agent may be glycerol, and the solvent may be water.

Glycerol may account for 50 wt % to 100 wt % of the reducing component 108.

The arranging the reducing component may include jetting, and the glycerol may account for 50 wt % to 70 wt % of the reducing component 108.

The reducing agent may be glycerol and the solvent may be diethylenglycolmonoethylether (DEGMEE), and, optionally, the glycerol accounts for 30 wt % to 100 wt % of the reducing component.

The arranging the reducing component may include jetting, and the glycerol may account for 30 wt % to 50 wt % of the reducing component 108.

In various embodiments, a combination of reducing component 108 and method of arranging it may be adjusted and experimentally verified for optimal results.

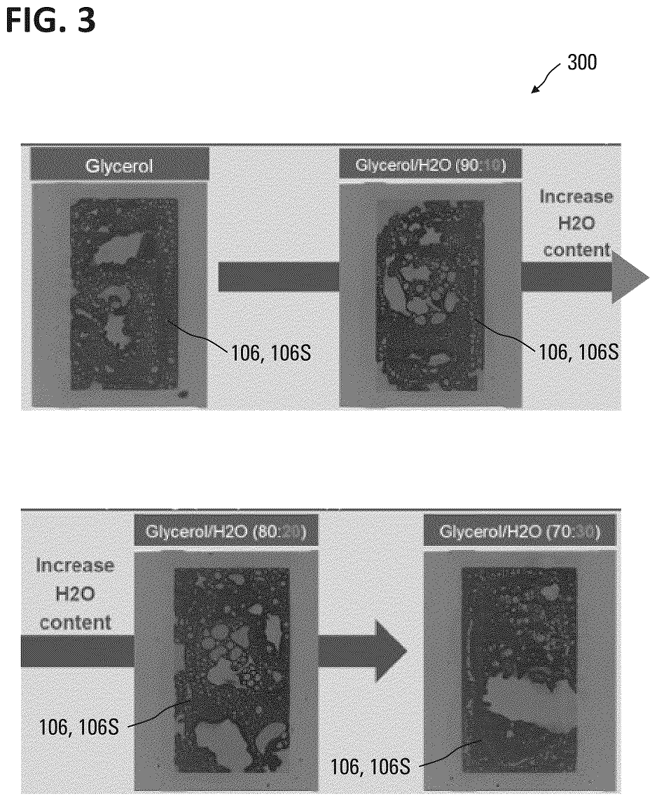

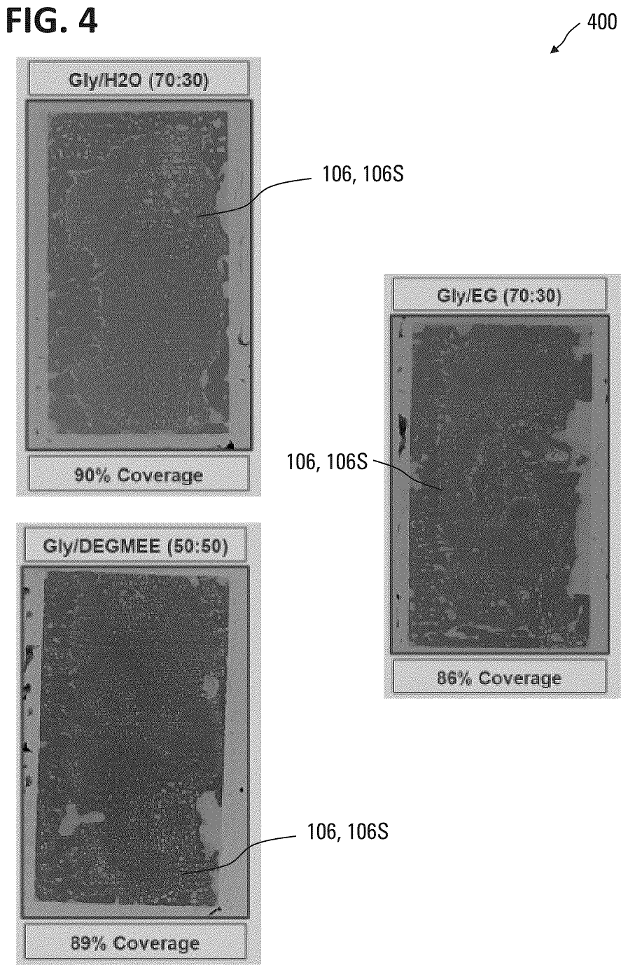

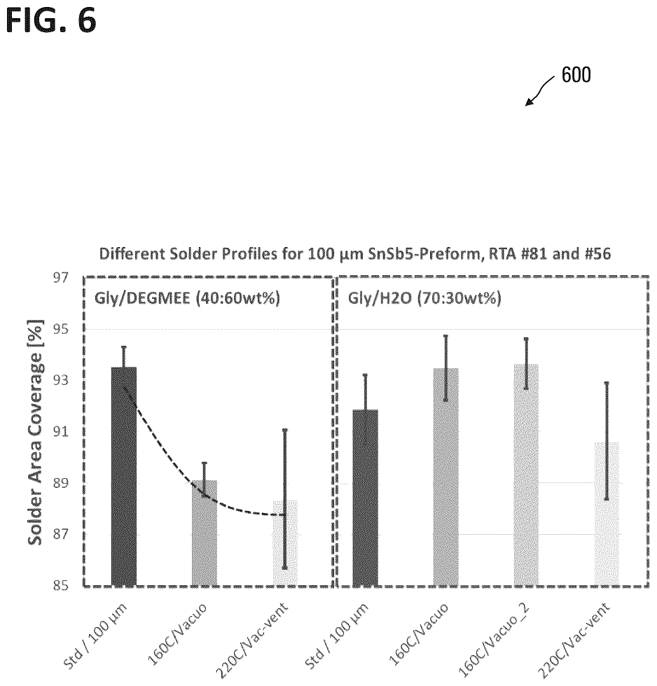

FIGS. 3 and 4 each show solder distributions of various embodiments having been formed by a soldering method in accordance with various embodiments, and FIG. 6 graphically illustrates a solder area coverage for different solder profiles of the soldering method in accordance with various embodiments. Each of these figures indicates that a suitable reducing component 108 leads to a large solder area coverage. However, experiments may further lead to an optimization of the area coverage. For example, using a glycerol-DEGMEE (50:50) reducing component 108, the area coverage is consistently large irrespective of a jetting pattern, whereas a glycerol-water (70:30) reducing component may show a larger dependency of area coverage on a jetting pattern, but a larger maximum area coverage for a certain jetting pattern (4×3 shots) than with the same jetting pattern pr the glycerol-DEGMEE reducing component 108.

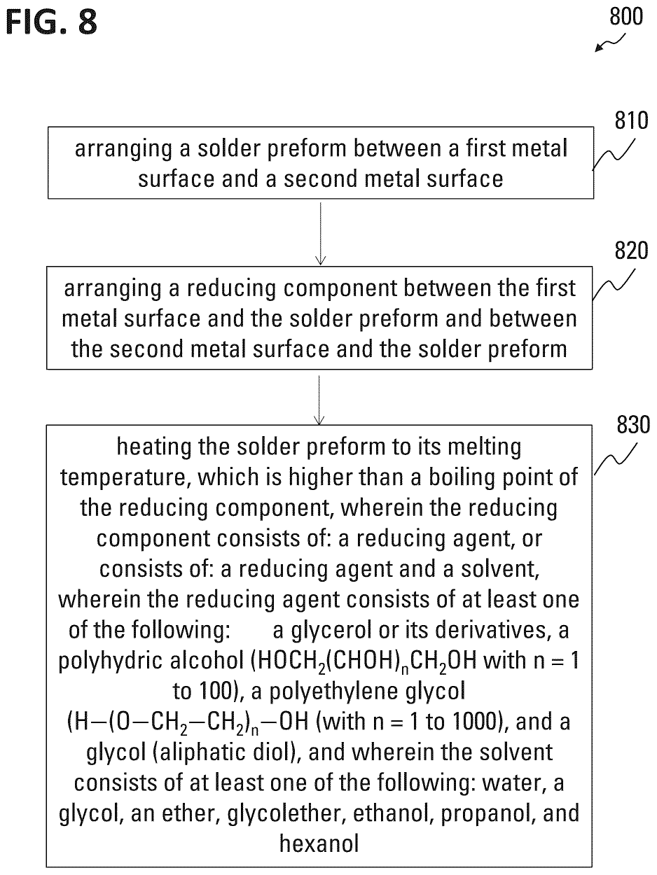

FIG. 8 shows a flow diagram 800 of a soldering method in accordance with various embodiments.

The soldering method may include arranging a solder preform between a first metal surface and a second metal surface (810), arranging a reducing component between the first metal surface and the solder preform and between the second metal surface and the solder preform (820), and heating the solder preform to its melting temperature, which is higher than a boiling point of the reducing component, wherein the reducing component consists of: a reducing agent, or consists of: a reducing agent and a solvent, wherein the reducing agent consists of at least one of the following: a glycerol or its derivatives, a polyhydric alcohol (HOCH₂ (CHOH)ₙCH₂OH with n=1 to 100), a polyethylene glycol (H—(O—CH₂—CH₂)ₙ—OH (with n=1 to 1000), and a glycol (aliphatic diol), and wherein the solvent consists of at least one of the following: water, a glycol, an ether, glycolether, ethanol, propanol, and hexanol (830).

Various examples will be illustrated in the following:

Example 1 is a soldering method. The soldering method includes arranging a solder preform between a first metal surface and a second metal surface, arranging a reducing component between the first metal surface and the solder preform and between the second metal surface and the solder preform, and heating the solder preform to its melting temperature, which is higher than a boiling point of the reducing component, wherein the reducing component consists of: a reducing agent, or consists of: a reducing agent and a solvent, wherein the reducing agent consists of at least one of the following: a glycerol or its derivatives, a polyhydric alcohol (HOCH₂ (CHOH)ₙCH₂OH with n=1 to 100), a polyethylene glycol (H—(O—CH₂—CH₂)ₙ—OH (with n=1 to 1000), and a glycol (aliphatic diol), and wherein the solvent consists of at least one of the following: water, a glycol, an ether, glycolether, ethanol, propanol, and hexanol.

In Example 2, the subject-matter of Example 1 may optionally include that a viscosity of the reducing component is in a range from 1 mPa s to 1000 mPa s.

In Example 3, the subject-matter of Example 1 or 2 may optionally include that a viscosity of the reducing component is in a range from 1 mPas to 60 mPa s.

In Example 4, the subject-matter of Example 3 may optionally include that the arranging the reducing component includes jetting.

In Example 5, the subject-matter of Example 4 may optionally further include heating the reducing component to a temperature that reduces the viscosity of the reducing component to 60 mPa s or lower.

In Example 6, the subject-matter of any of Examples 1 to 3 may optionally further include that the arranging the reducing component includes dispensing or squeegeeing.

In Example 7, the subject-matter of any of Examples 1 to 6 may optionally further include that a boiling point of the reducing component is in a range from 80° C. to 290° C., for example between 120° C. and 180° C.

In Example 8, the subject-matter of any of Examples 1 to 7 may optionally further include that a surface tension of the reducing component is in a range from 1×10⁻³ N/m to 80×10⁻³ N/m, for example between 1×10⁻³ N/m and 50×10⁻³ N/m.

In Example 9, the subject-matter of any of Examples 1 to 8 may optionally further include that a vapor pressure of the reducing component is in a range from 0.1 Pa to 2000 Pa, for example between 10 Pa and 1000 Pa.

In Example 10, the subject-matter of any of Examples 1 to 9 may optionally further include that a melting point of the reducing component is below 20° C., for example below 15° C.

In Example 11, the subject-matter of any of Examples 1 to 10 may optionally further include that the arranging a reducing component between the first metal surface and the solder preform includes, before the arranging the solder preform, arranging the reducing component on the solder preform and/or on the first metal surface, and/or that the arranging a reducing component between the second metal surface and the solder preform includes, before the arranging the solder preform, arranging the reducing component on the solder preform and/or on the second metal surface.

In Example 12, the subject-matter of any of Examples 1 to 11 may optionally further include that the reducing agent accounts for 10 wt % to 100 wt % of the reducing composition.

In Example 13, the subject-matter of any of Examples 1 to 12 may optionally further include that the reducing agent is glycerol and wherein the solvent is water.

In Example 14, the subject-matter of Example 13 may optionally include that the glycerol accounts for 50 wt % to 100 wt % of the reducing component.

In Example 15, the subject-matter of Example 14 may optionally include that the arranging the reducing component includes jetting, and wherein the glycerol accounts for 50 wt % to 70 wt % of the reducing component.

In Example 16, the subject-matter of any of Examples 1 to 12 may optionally further include that the reducing agent is glycerol and wherein the solvent is diethylenglycolmonoethylether (DEGMEE).

In Example 17, the subject-matter of Example 16 may optionally include that the glycerol accounts for 30 wt % to 100 wt % of the reducing component.

In Example 18, the subject-matter of Example 14 may optionally include that the arranging the reducing component includes jetting, and wherein the glycerol accounts for 30 wt % to 50 wt % of the reducing component.

In Example 19, the subject-matter of any of Examples 1 to 18 may optionally further include that the reducing agent is glycerol and wherein the solvent is diethylenglycolmonoethylether (DEGMEE).

In Example 20, the subject-matter of any of Examples 1 to 19 may optionally further include that the preform includes or consists of at least one of the following list of solder materials: Sn, SnAg, SnAgCu, e.g. SAC305, SnCu, and SnSb, e.g. SnSb₂, SnSb₅, or SnSb₁₀.

In Example 21, the subject-matter of any of Examples 1 to 20 may optionally further include that the first metal surface and/or the second metal surface includes or consists of at least one of the following list of metals: Ag, Au, Cu, Ni, NiP, Pd, Al/Ti/NiV/Ag, Al/Ti/NiV/Au, Ti/NiV/Ag, Ti/NiV/Au, and NiSi/Ti/NiV/Ag.

In Example 22, the subject-matter of any of Examples 1 to 21 may optionally further include that the first metal surface includes or consists of the same metal or metals as the second metal surface, or that a metal or metals of the first metal surface differ from the metal or metals of the second metal surface.

In Example 23, the subject-matter of any of Examples 1 to 22 may optionally further include that the heating the solder preform is conducted under a nitrogen atmosphere or in a vacuum.

In Example 24, the subject-matter of any of Examples 1 to 23 may optionally further include that a thickness of the solder preform is in a range from 7 μm to 200 μm.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A soldering method, comprising:
arranging a solder preform between a first metal surface and a second metal surface;
arranging a reducing component between the first metal surface and the solder preform and between the second metal surface and the solder preform; and
heating the solder preform to its melting temperature, which is higher than a boiling point of the reducing component;
wherein the reducing component consists of:
a reducing agent;
or consists of:
a reducing agent; and
a solvent;
wherein the reducing agent consists of at least one of the following:
a glycerol or its derivatives;
a polyhydric alcohol (HOCH₂(CHOH)ₙCH₂OH with n=1 to 100);
a polyethylene glycol (H—(O—CH₂—CH₂)ₙ—OH (with n=1 to 1000); and
a glycol (aliphatic diol); and
wherein the solvent consists of at least one of the following:
water;
a glycol;
an ether;
glycolether;
ethanol;
propanol; and
hexanol.

2. The method of claim 1,
wherein a viscosity of the reducing component is in a range from 1 mPa s to 1000 mPa s.

3. The method of claim 1,
wherein a viscosity of the reducing component is in a range from 1 mPas to 60 mPa S.

4. The method of claim 3,
wherein the arranging the reducing component comprises jetting.

5. The method of claim 4, further comprising:
heating the reducing component to a temperature that reduces the viscosity of the reducing component to 60 mPa s or lower.

6. The method of f claim 1,
wherein the arranging the reducing component comprises dispensing or squeegeeing.

7. The method of claim 1,
wherein a boiling point of the reducing component is in a range from 80° C. to 290° C., for example between 120° C. and 180° C.

8. The method of claim 1,
wherein a surface tension of the reducing component is in a range from 1×10⁻³ N/m to 80×10⁻³ N/m, for example between 1×10⁻³ N/m and 50×10⁻³ N/m.

9. The method of claim 1,
wherein a vapor pressure of the reducing component is in a range from 0.1 Pa to 2000 Pa, for example between 10 Pa and 1000 Pa.

10. The method of claim 1,
wherein a melting point of the reducing component is below 20° C., for example below 15° C.

11. The method of claim 1,
wherein the arranging a reducing component between the first metal surface and the solder preform comprises, before the arranging the solder preform, arranging the reducing component on the solder preform and/or on the first metal surface; and/or
wherein the arranging a reducing component between the second metal surface and the solder preform comprises, before the arranging the solder preform, arranging the reducing component on the solder preform and/or on the second metal surface.

12. The method of claim 1,
wherein the reducing agent accounts for 10 wt % to 100 wt % of the reducing composition.

13. The method of claim 1,
wherein the reducing agent is glycerol and wherein the solvent is water.

14. The method of claim 13,
wherein the glycerol accounts for 50 wt % to 100 wt % of the reducing component.

15. The method of claim 14,
wherein the arranging the reducing component comprises jetting, and wherein the glycerol accounts for 50 wt % to 70 wt % of the reducing component.

16. The method of claim 1,
wherein the reducing agent is glycerol and wherein the solvent is diethylenglycolmonoethylether (DEGMEE).

17. The method of claim 16,
wherein the glycerol accounts for 30 wt % to 100 wt % of the reducing component.

18. The method of claim 14,
wherein the arranging the reducing component comprises jetting, and wherein the glycerol accounts for 30 wt % to 50 wt % of the reducing component.

19. The method of claim 1,
wherein the reducing agent is glycerol and wherein the solvent is diethylenglycolmonoethylether (DEGMEE).

20. The method of claim 1,
wherein the preform comprises or consists of at least one of the following list of solder materials:
Sn;
SnAg;
SnAgCu, e.g. SAC305;
SnCu; and
SnSb, e.g. SnSb₂, SnSb₅, or SnSb₁₀.

21. The method of claim 1,
wherein the first metal surface and/or the second metal surface comprises or consists of at least one of the following list of metals:
Ag;
Au;
Cu;
Ni;
NiP;
Pd;
Al/Ti/NiV/Ag;
Al/Ti/NiV/Au;
Ti/NiV/Ag;
Ti/NiV/Au; and
NiSi/Ti/NiV/Ag.

22. The method of claim 1,
wherein the first metal surface comprises or consists of the same metal or metals as the second metal surface; or
wherein a metal or metals of the first metal surface differ from the metal or metals of the second metal surface.

23. The method of claim 1,
wherein the heating the solder preform is conducted under a nitrogen atmosphere or in a vacuum.

24. The method of claim 1,
wherein a thickness of the solder preform is in a range from 7 μm to 200 μm.
